(19) United States
(12) Patent Application Publication
(10) Pub. No.: US 2014/0115257 A1
(43) Pub. Date: Apr. 24, 2014

(54) PREFETCHING USING BRANCH INFORMATION FROM AN INSTRUCTION CACHE

(71) Applicant: ADVANCED MICRO DEVICES, INC., Sunnyvale, CA (US)

(72) Inventor: James D. Dundas, Austin, TX (US)

(73) Assignee: Advanced Micro Devices, Inc., Sunnyvale, CA (US)

(21) Appl. No.: 13/657,254

(22) Filed: Oct. 22, 2012

(51) Int. Cl. G06F 12/08

(52) U.S. Cl. 711/125; 711/E12.02

(57) ABSTRACT

A processor stores branch information at a “sparse” cache and a “dense” cache. The sparse cache stores the target addresses for up to a specified number of branch instructions in a given cache entry associated with a cache line address, while branch information for additional branch instructions at the cache entry is stored at the dense cache. Branch information at the dense cache persists after eviction of the corresponding cache line until it is replaced by branch information for a different cache entry. Accordingly, in response to the instructions for a given cache line address being requested for retrieval from memory, a prefetcher determines whether the dense cache stores branch information for the cache line address. If so, the prefetcher prefetches the instructions identified by the target addresses of the branch information in the dense cache concurrently with transferring the instructions associated with the cache line address.

### FIELD OF THE DISCLOSURE

The present disclosure relates to processors and more particularly to prefetching for processors.

### BACKGROUND

Prefetching techniques are employed in processors to speculatively fetch instructions from memory in anticipation of their use at later time. Typically, a prefetch operation for instruction data involves an instruction pipeline initiating a memory access request to access the prefetch instructions from memory and storing the prefetched instructions in an instruction cache. The particular instructions to be prefetched can be determined according to a number of techniques. One technique involves prefetching instructions from specific memory locations in relation to the instructions being fetched to the instruction cache. For example, in response to particular instructions being fetched to the instruction cache, instructions stored sequentially in memory after the fetched instructions can be prefetched.

Another prefetching technique is to use a decoupled instruction pipeline front end that runs in parallel to the main instruction pipeline that is fetching instructions. The decoupled instruction pipeline “runs ahead” of the main instruction pipeline and identifies instructions that are likely to be executed at the main instruction pipeline. The main pipeline prefetches at least a subset of the identified instructions. Another technique is to prefetch instructions based on branch prediction information. For example, the instruction pipeline can prefetch instructions for branches that are not predicted to be taken, so that the prefetched instructions are ready for execution in the event of a mispredicted branch.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of an electronic device including a processor and memory in accordance with some embodiments.

FIG. 2 is a diagram illustrating an example of prefetching instructions at a processor of FIG. 1 in accordance with some embodiments.

FIG. 3 is a diagram illustrating another example of prefetching instructions at the processor of FIG. 1 in accordance with some embodiments.

FIG. 4 is a diagram illustrating still another example of prefetching instructions at the processor of FIG. 1 in accordance with some embodiments.

FIG. 5 is a diagram illustrating another example of prefetching instructions at the processor of FIG. 1 in accordance with some embodiments.

FIG. 6 is a flow diagram of a method of prefetching instructions at the processor of FIG. 1 in accordance with some embodiments.

FIG. 7 is a flow diagram illustrating a method for designing and fabricating an integrated circuit device implementing at least a portion of a component of a processing system in accordance with some embodiments.

The use of the same reference symbols in different drawings indicates similar or identical items.

### DETAILED DESCRIPTION

In some embodiments, a processor enhances processing efficiency by prefetching data based on stored target addresses of branch instructions in a set of instructions being transferred to an instruction cache. The processor stores branch information at two different branch information caches, referred to as a “sparse” cache and a “dense” cache. The sparse cache stores the target addresses for up to a specified number (e.g. two) of branch instructions in a given cache entry associated with a cache line address, while the dense cache stores branch information for additional branch instructions at the cache entry. Branch information at the dense cache persists after eviction of the corresponding cache line until it is replaced by branch information for a different cache entry. Accordingly, in response to the instructions for a given cache line address being requested for retrieval from memory, a prefetcher determines whether the dense cache stores branch information for the cache line address. If so, the prefetcher prefetches the instructions identified by the target addresses of the branch information in the dense cache concurrently with transferring the instructions associated with the cache line address. The instructions targeted by the branch instructions of the cache line are therefore available at the instruction cache in the event their associated branch instructions are taken or predicted to be taken, thereby improving processing efficiency.

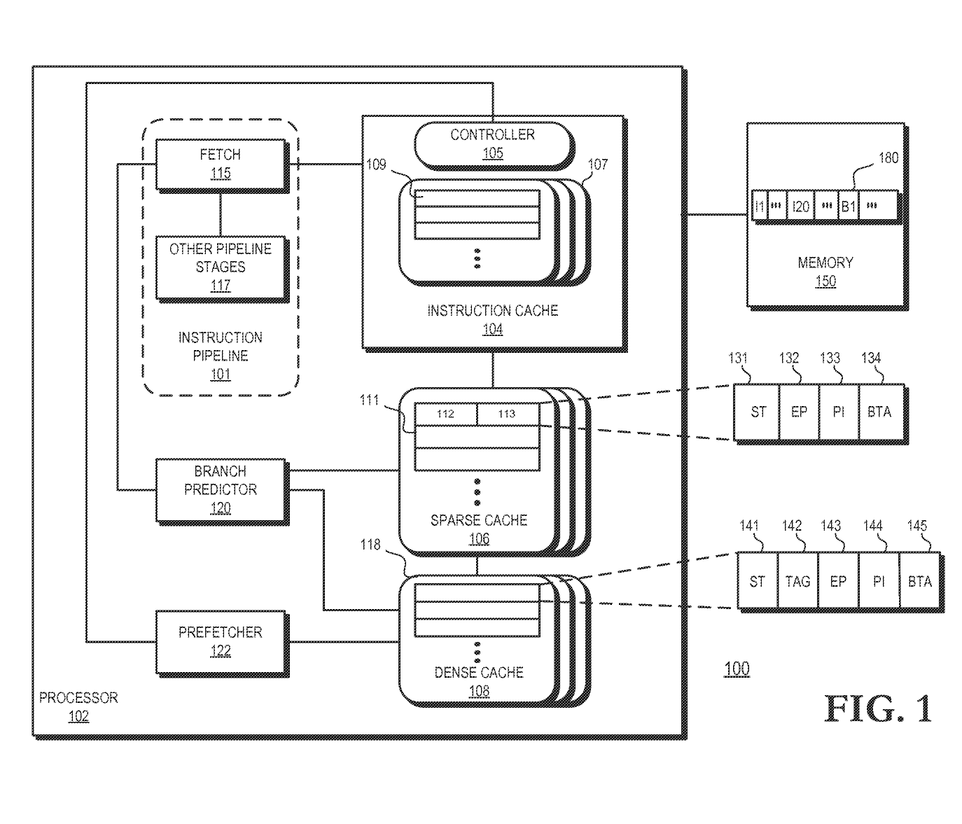

FIG. 1 illustrates a block diagram of an electronic device 100 including a processor core 102 and a memory 150 in accordance with some embodiments. The electronic device 100 can be any device that employs a processor, such as a personal computer, server, personal or hand-held electronic device, telephone, and the like. The processor core 102 is generally configured to execute sets of instructions, referred to as computer programs, in order to carry out tasks designated by the computer programs stored at the memory 150. The execution of sets of instructions by the processor core 102 primarily involves the storage, retrieval, and manipulation of information, including instructions and data. The processor core 102 can include, for example, a central processing unit (CPU) core, a graphics processing unit (GPU) core, or a combination thereof. The memory 150 can be volatile memory, such as random access memory (RAM), non-volatile memory, such as flash memory, a disk drive, or any combination thereof.

The processor core 102 includes an instruction pipeline 101 that performs the operations of determining the set of instructions to be executed and executing those instructions by causing instructions, operands, and other such data to be transferred from the memory 150, manipulating the operands according to the instructions, and causing the results to be stored at the memory 150. It will be appreciated that although a single instruction pipeline 101 is illustrated for ease of discussion, the processor core 102 can include multiple processor instruction pipelines to execute instructions at one or more processor cores.

The instruction pipeline 101 includes a fetch stage 115 and other pipeline stages 117. The fetch stage 115 is configured to retrieve instructions for execution based on a program order of the computer program being executed. In order to retrieve an instruction, the fetch stage 115 issues a request, referred to as an “instruction demand” indicating an address, referred to as the “instruction demand address”, of the requested instruction. As described further below, the requested instruction is provided to the fetch stage 115 by an instruction cache 104. In response to receiving the instruction, the fetch stage 115 provides the instruction to the other pipeline stages 117 for processing. The other pipeline stages 117 can include a decode stage, dispatch stage, execution stage, retire stage, and other stages that process the instructions provided by the fetch stage 115.

The instruction cache 104 including a controller 105 and a storage array 107. In some embodiments, the controller 105 configures the storage array as an N-way set associative cache, whereby each way of the cache includes a different plurality of cache entries, such as cache entry 109, and where each cache entry of the storage array 107 is sized such that it can store multiple instructions. The controller 105 is configured to satisfy instruction demands received from the fetch stage 115 by storing and retrieving data from cache entries. To illustrate, in response to an instruction demand, the controller 105 determines, based on the instruction demand address, if a cache entry of the storage array 107 stores the instruction associated with the instruction demand address. If so, the controller 105 determines a cache hit and retrieves the instruction from the cache line and provides it to the fetch stage 115.

If the storage array 107 does not store the instruction associated with the instruction demand address, the controller 105 determines a cache miss and requests the instruction from the memory 150 for transfer to the instruction cache 104. In some embodiments, the controller 105 is configured to request instructions from the memory 150 at the granularity of a cache entry. To illustrate, if each cache entry has a size M, the portion of the memory 150 that stores instructions is logically divided into P segments each having size M. Each of the P segments is logically divided into L sub-segments that are each associated with a different corresponding instruction demand address. Each of the P segments is referred to as a cache line, and each cache line is associated with a different corresponding address, referred to as a “cache line address.” Each cache line stores a particular set of instructions. For ease of discussion, a cache line is referred to according to the first instruction of the cache line's set of instructions. For example, in the illustrated embodiment of FIG. 1 the memory 150 stores a cache line 180 with a first instruction designated “I1.” Accordingly, the cache line 180 is referred to as the “I1” cache line.

To transfer an instruction from the memory 150, the controller 105 determines the cache line address associated with the demand address and provides the cache line address to the memory 150. In response, the memory 150 provides all of the data stored at the segment to the controller 105, which stores the data at a cache line of the storage array 107. To illustrate by way of example, the I1 cache line stored at memory 150 is associated with a cache line address referred to as “cache line address A.” The cache line 180 stores multiple instructions, such as the instruction I1, an instruction I20, and a branch instruction B1. Each of the instructions at the I1 cache line is associated with a different corresponding instruction demand address. For example, instruction I1 is associated with an instruction demand address referred to as “instruction demand address A” while instruction I20 is associated with an instruction demand address referred to as “instruction demand address B.” In response to a cache miss for any instruction demand address associated with I1 cache line, the controller 105 transfers the I1 cache line from the memory 150 and stores it at a cache line of the storage array 107. For example, in response to receiving an instruction demand for instruction demand address B and determining that the storage array 107 does not store the I1 cache line, the controller 105 will determine a cache miss. In response, the controller 105 determines that instruction demand address B is associated with cache line address A. Accordingly, the controller 105 provides the cache line address A to the memory 150, which provides the I1 cache line in response.

Because the storage array 107 is configured as an N-way set associative cache, each cache line can only be stored at a corresponding set of entries at the storage array 107, where the set that can store a cache line is based on the cache line address. Further, the number of cache lines that are associated with a set of the storage array 107 is greater than the number of entries in the set. Accordingly, the controller 105 is configured to, in response to transferring a cache line from the memory 150, determine if there is an empty entry in the segment's associated set. If so, the controller 105 stores the transferred cache line at the empty entry. If there is no empty entry, the controller 105 selects one of the entries in the set and replaces the cache line at the selected entry with the cache line transferred from the memory 150. The cache line that is replaced at the selected cache line is referred to as being “evicted” from the instruction cache 104.

The processor core 102 includes a pair of caches, designated sparse cache 106 and dense cache 108, to store information about branch instructions stored at the instruction cache 104. As described further herein, the branch instruction information stored at the sparse cache 106 and the dense cache 108 allows the processor core 102 to more efficiently conduct speculative operations such as branch prediction and prefetching of instructions. The sparse cache 106 is configured as an N-way set associative cache, with each way having a number of entries, such as entry 111. Each entry of the sparse cache 106 corresponds to a different entry the instruction cache 104 and stores information about up to M branch instructions stored at the corresponding entry of the instruction cache 104. In particular, each entry of the sparse cache 106 includes a set of subentries, with each subentry storing information about a corresponding one of the branch instructions stored at the corresponding entry of the instruction cache 104. For example, in the illustrated embodiment of FIG. 1, M is equal to two, so each entry of the sparse cache 106 includes up to two subentries that store information about a corresponding branch instruction stored at the corresponding entry of the instruction cache 104. Thus, entry 111 includes a subentry 112 and a subentry 113, each of which store information about a corresponding branch instruction at the cache line stores at the corresponding entry of the instruction cache 104.

Each subentry of the sparse cache 106 includes a set of fields, including a state field 131, an end pointer field 132, a branch prediction information field 133, and a branch target address field 134. The state field 131 stores information about the state of the corresponding subentry, such as whether it stores valid information (e.g. a valid bit). The end pointer field 132 stores address information indicating the last byte (also referred to as the end byte), or set of last bytes, of the branch instruction corresponding to the subentry. The end pointer field 132 thus identifies the branch instruction corresponding to the subentry. The branch prediction information field 133 stores information that can be employed to determine whether to predict that the branch instruction corresponding to the subentry should be speculatively executed. For example, the branch prediction information field 133 can store information (sometimes referred to as branch type information) indicating a type of the corresponding branch instruction, such as whether the branch instruction is a direct or indirect branch instruction, the frequency with which the branch instruction has been taken over a particular period (e.g. whether the branch instruction is always taken, never taken, or taken a certain number of times), and the like. The branch target address field 134 stores information indicating the target address of the corresponding branch instruction.

The dense cache 108 is configured to store information about branch instructions for cache lines stored at the instruction cache 104 when the number of branch instructions at a cache line exceeds the number that can be stored at the corresponding entry of the sparse cache 106. For example, in the illustrated embodiment the sparse cache 106 can store information about up to two branch instructions of a given cache line stored at the instruction cache 104. If the number of branch instructions exceeds two, the information about the additional branch instructions is stored at the dense cache 108. In some embodiments, the majority of cache lines at the instruction cache 104 will typically have two or fewer branch instructions. This allows the dense cache 108 to be sized such that it is smaller than the sparse cache 106. Accordingly, by dividing branch instruction information between the sparse cache 106 and the dense cache 108, the processor core 102 can accommodate cache lines having more than two branch instructions without making the sparse cache 106 inefficiently large.

The dense cache 108 is configured as an R-way set associative cache, with each way having a number of entries such as entry 118. Each of the entries at the dense cache 108 can be assigned to store information for branch instructions of cache line stored at the instruction cache 104. In particular, each entry of the dense cache 108 can include one or more subentries, whereby each subentry stores information for a corresponding branch instruction of a cache line. Each subentry includes a state field 141, a tag field 142, an end pointer field 143, a branch prediction information field 144, and a branch target address field 145. The state field 141 stores information about the state of the corresponding subentry, such as whether it stores valid information. The tag field 142 stores address information indicating the cache line address for the branch instruction corresponding to the subentry. The tag field 142 provides a way to identify which cache line of the instruction cache 104 stores the branch instruction corresponding to the subentry. In some embodiments, the tag field 142 is a micro-tag that stores only a portion of the address information used to identify the address of cache line. In these embodiments, the cache line can be determined by combining the tag field 142 with other information, such as the set index for the entry and the end pointer filed 143. The end pointer field 143, prediction information field 144, and branch target address field 145 store similar information as the corresponding fields of the sparse cache 106. In some embodiments, each entry of the sparse cache 106 can also include a set of information, referred to as a dense vector, indicating whether or not the dense cache 108 stores branch information for the corresponding entry of the instruction cache 104, and which portions of the entry of the instruction cache 104 store the branches for which information is stored at the dense cache 108. The dense vector can provide for more efficient access of the dense cache 108. For example, in some embodiments the entries of the dense cache 108 are generally kept in a reduced power state, and the dense vector is used to determine which entries to place in a normal power state for access.

The processor core 102 includes a branch predictor 120 and a prefetcher 122 to perform speculative operations based on the branch information stored at the sparse cache 106 and the dense cache 108. The branch predictor 120 is configured to predict, based on the branch information, which branches stored at entries of the instruction cache 104 will be taken in the course of executing instructions at the instruction pipeline 101. Thus, for example, the branch predictor 120 can analyze the prediction information fields for subentries at the sparse cache 106 and, for those branch instructions whose prediction information indicates that the branch is always taken, or taken greater than a threshold number of times, or identified based on another branch prediction algorithm, the branch predictor 120 can provide the branch target addresses of the branch instructions to the fetch stage 115. In response, the fetch stage 115 can issue an instruction demand for the instructions indicated by the branch target addresses, thereby initiating speculative execution of the branches. The other pipeline stages 117 determine which branches are actually taken by execution of the set of instructions, and can correct any mispredictions by the branch predictor 120.

The branch predictor 120 manages the allocation of entries at the sparse cache 106 and dense cache 108 to store branch information for branch instructions. To illustrate, in response determining that a branch is predicted to be taken for the first time, the branch predictor 120 allocates an entry in either the sparse cache 106 or the dense cache 108 for the branch information of the predicted branch instruction. In particular, if there are fewer than 2 entries yet allocated in the sparse cache 106 to the cache line of the branch instruction, the branch predictor 120 allocates an entry of the sparse cache 106 for the predicted branch instruction. If there are 2 entries already allocated to the cache line, the controller 105 compares the end pointer of the new branch instruction to the end pointers of the branch instruction information stored at the corresponding entry of the sparse cache 106. If the end pointer of the new branch instruction indicates it is younger in program order, the controller moves the branch instruction information for the oldest branch instruction in program order to an entry of the dense cache 108, and the branch information for the new branch instruction is stored at the sparse cache 106. The sparse cache 106 thus stores the branch information for the predicted branch instructions that are younger in program order. If the new branch instruction is older in program order than the branch instructions associated with the corresponding entries of the sparse cache 106, the branch information for the branch instruction is provided to the controller 105 to determine whether to store the branch information for the branch instruction at the dense cache 108.

The branch predictor 120 receives branch information for branch instructions to be stored at the dense cache 108, either as a result of being moved from the sparse cache 106, or because the sparse cache 108 stores branch information for younger branch instructions at the corresponding cache line. Prior to storing received branch information at the dense cache 108, the controller 105 uses the branch address for the branch instruction as an index into the ways of the dense cache 108. The branch predictor compares the information at the tag fields of the indexed ways to the tag field of the branch information for the branch instruction to be stored. If there is a match, this indicates that the dense cache 108 already stores branch information for the branch instruction, and the received branch information is not stored. If there is not a tag match, one of the ways is selected for storage of the received branch information. In some embodiments, the branch predictor 120 first selects, from the indexed ways, a way that stores information indicated to be invalid. If there are no invalid entries at the indexed ways, the controller 105 selects the least recently used entry and replaces the branch information at the selected way with the received branch information.

In some embodiments, when a cache line is evicted from the instruction cache 104 the branch information for the corresponding entry of the sparse cache 106 is preserved by transferring the branch information to another storage location, such as a level 2 (L2) cache (not shown). In particular the L2 cache can include entries that store instructions for which sets of bits allocated to error control are not used. The unused error control bits can be used to store the branch information for entries of the sparse cache 106 corresponding to an evicted cache line. When a cache line is transferred to the instruction cache 104, the controller 105 retrieves the corresponding branch information stored at the L2 cache and stores it at the corresponding entry of the sparse cache 106. The L2 cache is thus used to “silo” the branch information at the sparse cache 106, reducing processor overhead. Because the dense cache 108 stores branch information for branch instructions that are less likely to be taken and to preserve space at the L2 cache, branch information at the dense cache 108 is not siloed and is therefore available for use in prefetching.

The prefetcher 122 is configured to prefetch instructions to the instruction cache 104 based on branch information stored at the dense cache 108. To illustrate, in response to requesting a set of instructions from the memory 150, the controller 105 provides the corresponding cache line address to the prefetcher 122. In response, the prefetcher 122 compares the cache line address (or a subset of the cache line address) to the tag fields of the subentries at the dense cache 108. A match indicates that the subentry stores branch information for the branch instructions associated with the cache line address. Accordingly, in response to determining a match, the prefetcher 122 requests the controller 105 to transfer from the memory 50 the instructions indicated by the branch target addresses of the branch instructions. The request is done concurrently with the retrieval of the set of instructions originally requested from the memory 150. The branch target instructions will therefore be available at the instruction cache 104 in the event that the branch target instructions are demanded by the fetch stage 115.

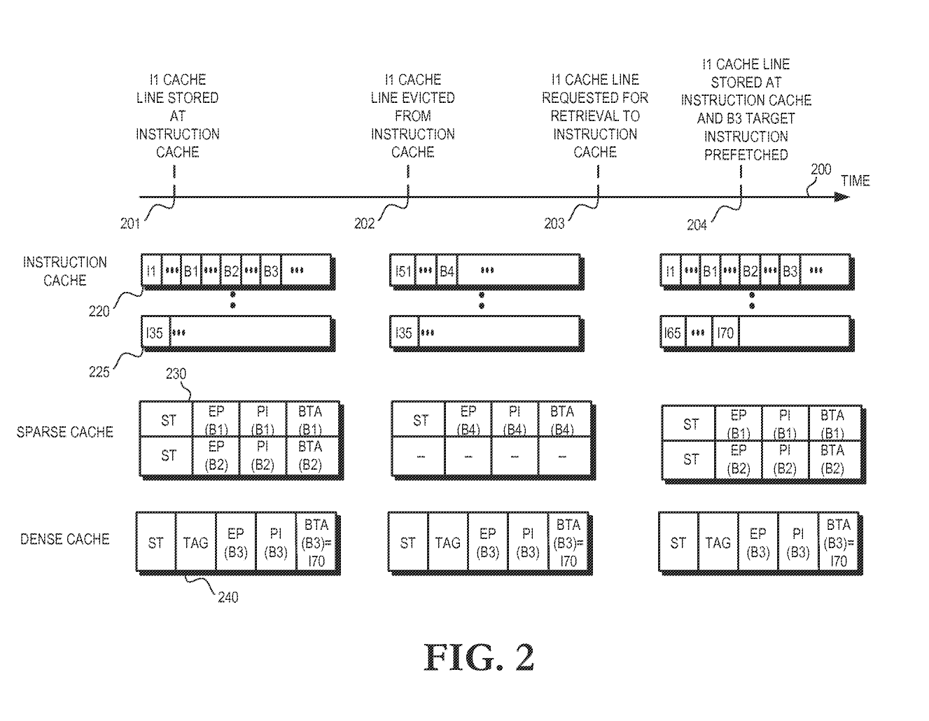

Operation of the prefetcher 122 can be better understood with reference to the example of FIG. 2. FIG. 2 illustrates a timeline 200 showing prefetching of instructions to the instruction cache 104 in accordance with some embodiments. In particular, FIG. 2 illustrates the contents of entries 220 and 225 of the instruction cache 104, entry 230 of the sparse cache 106, and entry 240 of the dense cache 108. For purposes of the example of FIG. 2, entry 230 of the sparse cache 106 corresponds to the entry 220 of the instruction cache 104.

Prior to time 201, the fetch stage 115 (FIG. 1) issues an instruction demand for an instruction of the I1 cache line. In response, the controller 105 determines the cache line address associated with the I1 cache line and determines a cache miss based on the cache line address. The controller 105 therefore requests the I1 cache line from the memory. Accordingly, at time 201, the I1 cache line is stored at cache line 220. As illustrated, the I1 cache line includes three branch instructions, designated “B1”, “B2”, and “B3”. The controller 105 transfers the branch information for B1 and B2 from their siloed location at the L2 cache and stores the branch information for B1 and B2 at respective subentries of entry 230 of sparse cache 106. In addition, it is assumed that the branch predictor 120 predicts that branch B3 will be taken. Because B3 is older in program order than the branch instructions B1 and B2, the controller 105 stores the branch information for B3 at entry 240 of dense cache 108. In addition, the controller 105 stores address information at the tag field of the entry 240 to indicate that entry 240 is assigned to the I1 cache line.

At time 202 the controller 105, based on received instruction demands, evicts the I1 cache line from cache line 220 and replaces it with the I51 cache line. Accordingly, the controller 105 replaces the branch information at entry 230 of sparse cache 106 with siloed branch information for the branch instructions of the I51 cache line. However, because the I51 cache line has less than three branch instructions predicted to be taken the branch information stored at entry 240 is not replaced. Instead, the controller 105 maintains (does not replace) the branch information stored at entry 240. Branch information stored at entry 240 is only evicted if another, non-evicted cache line associated with the entry 240 is determined to have three or more branches predicted to be taken. In that case, entry 240 is replaced with branch information of the non-evicted cache line.

At time 203 the controller 105 receives an instruction demand for an instruction associated with the I1 cache line. In response, the controller 105 requests the I1 cache line from the memory 150. Concurrently, the prefetcher 122 determines, based on the tag field of the entry 240, that the entry 240 of dense cache 108 stores branch information for the I1 cache line. In particular, the prefetcher 122 determines that entry 240 stores information for B3, and determines the target address of B3. The prefetcher 122 provides the target address to the controller 105, which determines the cache line address associated with the target address and requests the instructions stored at the cache line address from the memory 150. Accordingly, at time 204 the I1 instruction line has been stored at cache line 220. In addition, the target instruction of B3, designated “I70”, has been prefetched to the cache line 225. Thus, in the event that the fetch stage 115 issues an instruction demand for I70 (e.g. based on the branch B3 being taken or predicted to be taken), the instruction demand can be satisfied from the instruction cache 104, thereby improving processing efficiency.

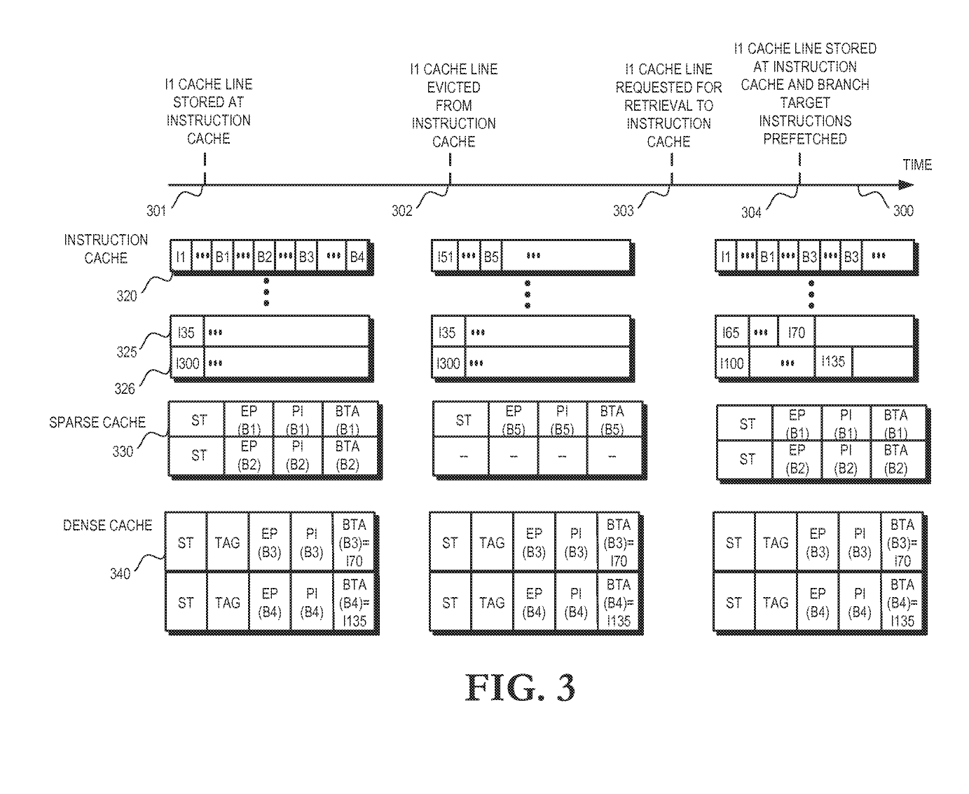

The prefetcher 122 can prefetch multiple cache lines based on branch information at dense cache 108, as illustrated in the example of FIG. 3. FIG. 3 illustrates a timeline 300 showing prefetching of instructions to the instruction cache 104 in accordance with some embodiments. FIG. 3 illustrates the contents of entries 320, 325, and 326 of the instruction cache 104, entry 330 of the sparse cache 106, and entry 340 of the dense cache 108. For purposes of the example of FIG. 3, entry 330 of the sparse cache 106 corresponds to the entry 320 of the instruction cache 104.

Prior to time 301, the set of instructions associated with the I1 cache line is stored at cache line 320. As illustrated, the I1 cache line includes four branch instructions, designated “B1”, “B2”, “B3”, and “B4”. The controller 105 retrieves branch information for B1 and B2 from the L2 cache, and stores it at respective subentries of entry 330 of sparse cache 106. In response to determining that branches B3 and B4 are taken, the branch predictor 120 stores the branch information for B3 and B4 at respective subentries of entry 340 of dense cache 108. In addition, the branch predictor 120 stores address information at the tag field of the subentries at entry 340 to indicate that entry 340 is assigned to the I1 cache line address. Thus, the entries of the sparse cache 106 are logical extensions of the corresponding cache line, while the entries of the dense cache 108 are separate structures that can be dynamically assigned to different instruction cache lines as needed to identify branches that cannot be stored at the sparse cache 106 because of its limited size.

At time 302 the controller 105, based on received instruction demands, evicts the I1 cache line from cache line 320 and replaces it with a cache line associated with instruction I51. Accordingly, the controller 105 replaces the branch information at entry 330 of sparse cache 106 with branch information for the branch instructions of the I51 cache line. However, maintains the branch information stored at entry 340 of the dense cache 108 is not evicted, but instead is maintained. That is, branch information at the dense cache 108 remains resident at the dense cache 108 after eviction of the corresponding cache line from the instruction cache 104. The branch information is therefore available for use in prefetching.

At time 303 the controller 105 receives an instruction demand for an instruction associated with the I1 cache line. In response, the controller 105 requests the I1 cache line from the memory 150. Concurrently, the prefetcher 122 determines, based on the tag field of the entry 340, that the entry 340 of dense cache 108 stores branch information for the I1 cache line. In particular, the prefetcher 122 determines that entry 340 stores information for B3 and B4, and determines the target addresses for each branch instruction. The prefetcher 122 provides the target addresses to the controller 105, which determines the cache line addresses associated with each target address and requests the instructions stored at the respective cache line addresses from the memory 150. Accordingly, at time 304 the I1 instruction line has been stored at cache line 320. In addition, the target instruction of B3, designated “I70”, has been prefetched to the cache line 325 and the target instruction of B4, designated “I135”, has been prefetched to the cache line 326.

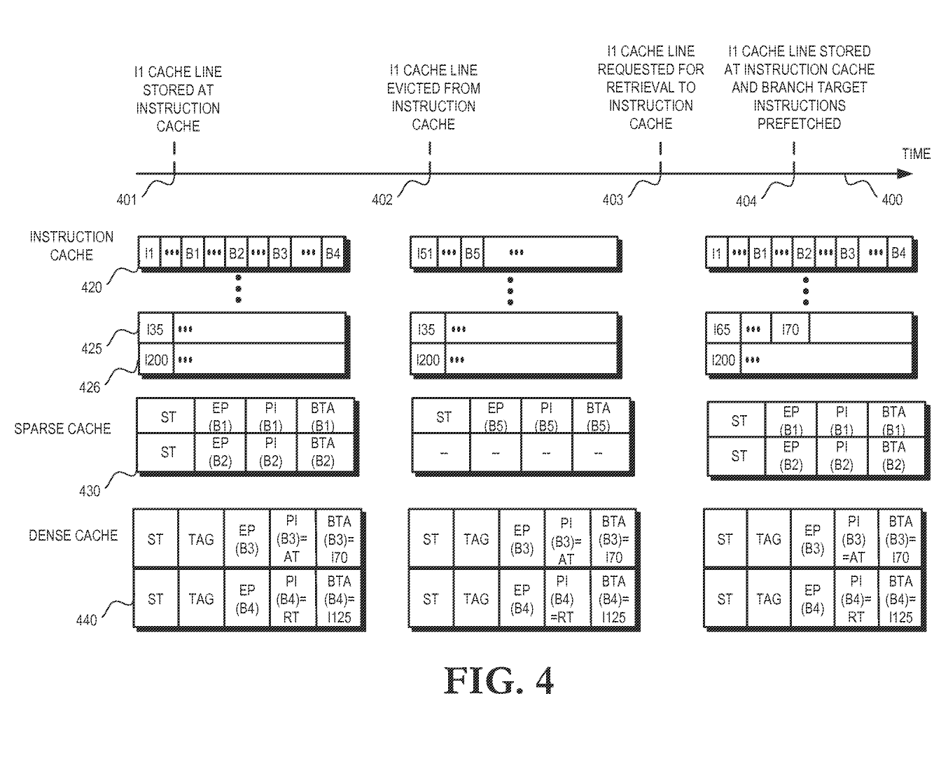

In some embodiments the prefetcher 122 prefetches only a subset (fewer than all) of the branch targets for a particular entry of the dense cache 108, thereby reducing the likelihood that prefetching will consume excessive resources of the instruction cache 104. For example, in some embodiments the prefetcher 122 prefetches only up to a threshold number of cache lines based on branch information stored at the dense cache 108. In some embodiments the prefetcher 122 determines whether a branch target instruction is to be prefetched based on the type of branch instruction. For example, the prefetcher 122 can determine whether a branch target instruction is to be prefetched based on whether the associated branch instruction is an indirect branch instruction or a direct branch instruction. As another example, the prefetcher 122 can determine whether a branch target instruction is to be prefetched based on the frequency with which the branch has previously been taken. This can be better understood with reference to FIG. 4.

FIG. 4 depicts a timeline 400 showing prefetching of instructions to the instruction cache 104 in accordance with some embodiments. FIG. 4 illustrates the contents of entries 420, 425, and 426 of the instruction cache 104, entry 430 of the sparse cache 106, and entry 440 of the dense cache 108. For purposes of the example of FIG. 4, entry 430 of the sparse cache 106 corresponds to entry 420 of the instruction cache 104.

Prior to time 401, the fetch stage 115 (FIG. 1) the set of instructions associated with the I1 cache line is stored at cache line 420. As illustrated, the instructions stored at cache line 420 includes four branch instructions, designated “B1”, “B2”, “B3”, and “B4”. The controller 105 retrieves the branch information for B1 and B2 from the L2 cache and stores the retrieved information at respective subentries of entry 430 of sparse cache 106. The branch predictor 120 also stores the branch information for B3 and B4 at respective subentries of entry 440 of dense cache 108. In addition, the controller 105 stores address information at the tag field of the subentries at entry 440 to indicate that entry 440 is assigned to the I1 cache line. Further, the controller 105 stores information at the prediction information fields of each subentry to indicate the number of times the corresponding branch instruction has previously been taken at the instruction pipeline 101. In the illustrated example, the controller 105 determines that B3 has a designation of “AT”, or always taken, indicating that B3 has been taken greater than a threshold number of times (e.g. taken one hundred percent of the time that it appears in a program order). The controller 105 determines that B4 has a designation of “RT”, or rarely taken, indicating that B4 has been taken less than a threshold number of times (e.g. taken less than sixty percent of the time that it appears in a program order). Accordingly, the controller 105 stores the information representing these designations at the corresponding prediction information fields of entry 440.

At time 402 the controller 105, based on received instruction demands, evicts the I1 cache line from cache line 420 and replaces it with the I51 cache line. Accordingly, the branch information at entry 430 of sparse cache 106 is replaced with branch information for the branch instructions of the I51 cache line. However, the controller 105 maintains the branch information stored at entry 440.

At time 403 the controller 105 receives an instruction demand for an instruction associated with the I1 cache line. In response, the controller 105 requests the I1 cache line from the memory 150. Concurrently, the prefetcher 122 determines, based on the tag fields of the entry 440, that the entry 440 of dense cache 108 stores branch information for the I1 cache line. In particular, the prefetcher 122 determines that entry 440 stores information for B3 and B4. In addition the prefetcher 122 determines, based on the prediction information at entry 440, that B3 is an always taken branch and that B4 is a rarely taken branch. Accordingly, the prefetcher 122 determines that the target instruction of B3 is to be prefetched, but that the target instruction of B4 is not to be prefetched. The prefetcher 122 therefore provides the target address for B3 to the controller 105, which determines the cache line address associated with the target address and requests the instructions stored at the cache line address from the memory 150. Accordingly, at time 404 the I1 instruction line has been stored at cache line 220. In addition, the target instruction of B3, designated “I70”, has been prefetched to the cache line 425. However, the target instruction of the B4, designated “I125”, is not prefetched to the instruction cache 104.

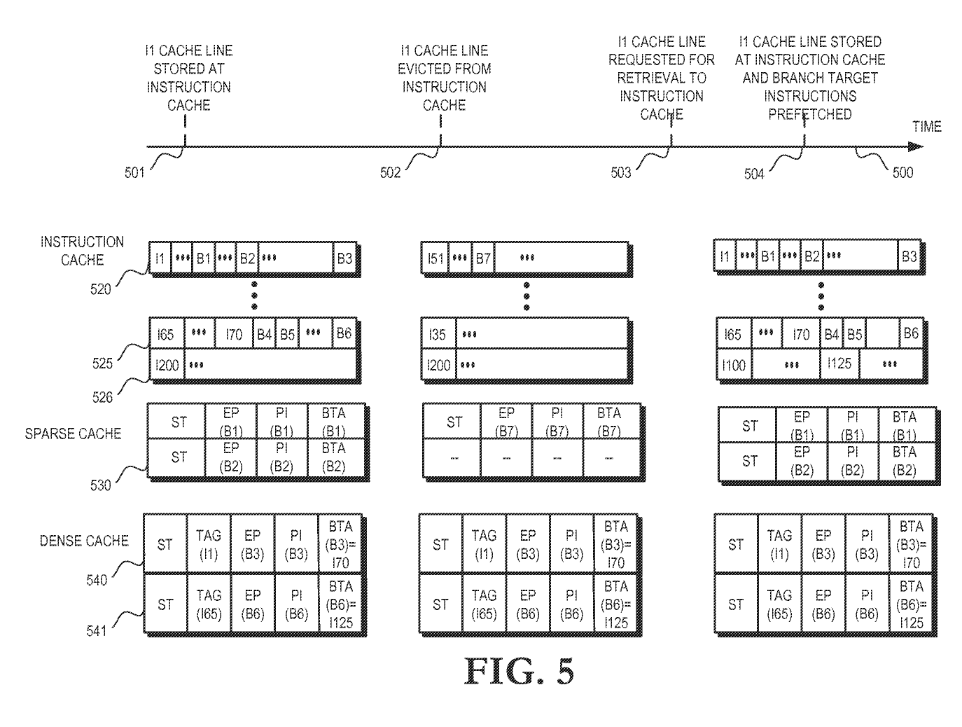

In some embodiments, the prefetcher 122 can prefetch instructions based on branch targets of branch instructions at prefetched cache lines. This is illustrated in the example of FIG. 5, which depicts a timeline 500 showing prefetching of instructions to the instruction cache 104 in accordance with some embodiments. FIG. 5 illustrates the contents of entries 520, 525, and 526 of the instruction cache 104, entry 530 of the sparse cache 106, and entries 540 and 541 of the dense cache 108. For purposes of the example of FIG. 5, entry 530 of the sparse cache 106 corresponds to the entry 520 of instruction cache 104.

Prior to time 501, the fetch stage 115 (FIG. 1) the set of instructions associated with the I1 cache line is stored at cache line 520 and the set of instructions associated with the I65 cache line (which includes an instruction I70) is stored at the cache line 525. As illustrated, the I1 cache line includes three branch instructions, designated “B1”, “B2”, and “B3”. The I51 cache line includes 3 branch instructions designated “B4”. “B5”, and “B6”. The controller 105 determines branch information for each of the branch instructions, and stores the branch information for B1 and B2 at respective subentries of entry 530 of the sparse cache 106. The controller 105 stores the branch information for B4 and B5 at another entry (not shown) of the sparse cache 106. The controller 105 also stores the branch information for B3 at entry 540 and stores the branch information for B6 at entry 541 of dense cache 108. In addition, the controller 105 stores address information at the tag fields of the entries 540 and 541 to indicate that the entries are respectively associated with the cache line address for the I1 cache line and the cache line address for the I65 cache line. In the illustrated example of FIG. 5, the branch target address for B3 corresponds to instruction I70, which is included in the set of instructions associated with I65. In response to prefetching the I1 cache line and in response to detecting the branch information at entry 541, the prefetcher is configured to also prefetch the I65 cache line.

To illustrate, at time 502 the controller 105, based on received instruction demands, evicts the I1 cache line from cache line 520 and replaces it with a cache line associated with instruction I51. Between time 501 and 502, the I65 cache line has also been evicted. Accordingly, the controller 105 replaces the branch information at entry 530 of sparse cache 106 with branch information for the branch instructions of the I51 cache line. However, the controller 105 maintains the branch information stored at entries 540 and 541 of dense cache 108.

At time 503 the controller 105 receives an instruction demand for an instruction associated with the I1 cache line. In response, the controller 105 requests the I1 cache line from the memory 150. Concurrently, the prefetcher 122 determines, based on the tag fields of the entry 540, that the entry 540 of dense cache 108 stores branch information for the I1 cache line. In particular, the prefetcher 122 determines that entry 540 stores information for B3. Accordingly, the prefetcher 122 determines that the target instruction of B3 is to be prefetched. The prefetcher 122 therefore provides the target address for B3 to the controller 105, which determines the cache line address associated with the target address and requests the instructions stored at the cache line address from the memory 150.

In addition, the prefetcher 122 determines that the branch target address stored at the entry 540 indicates an address for the instruction I70. The prefetcher 122 searches the entries of the dense cache 108 and determines that entry 541 stores information for the cache line address corresponding to instruction I70 (the I65 cache line). In response, the prefetcher 122 determines the branch target address for each of the branch instructions represented at entry 541 and requests the controller 105 to transfer the cache lines indicated by the target addresses from memory 150 in the event the cache lines are not already stored at the instruction cache 104. Thus, the prefetcher 122 is able to chain together prefetches by prefetching cache lines indicated as the target address of branch instructions in other prefetched cache lines.

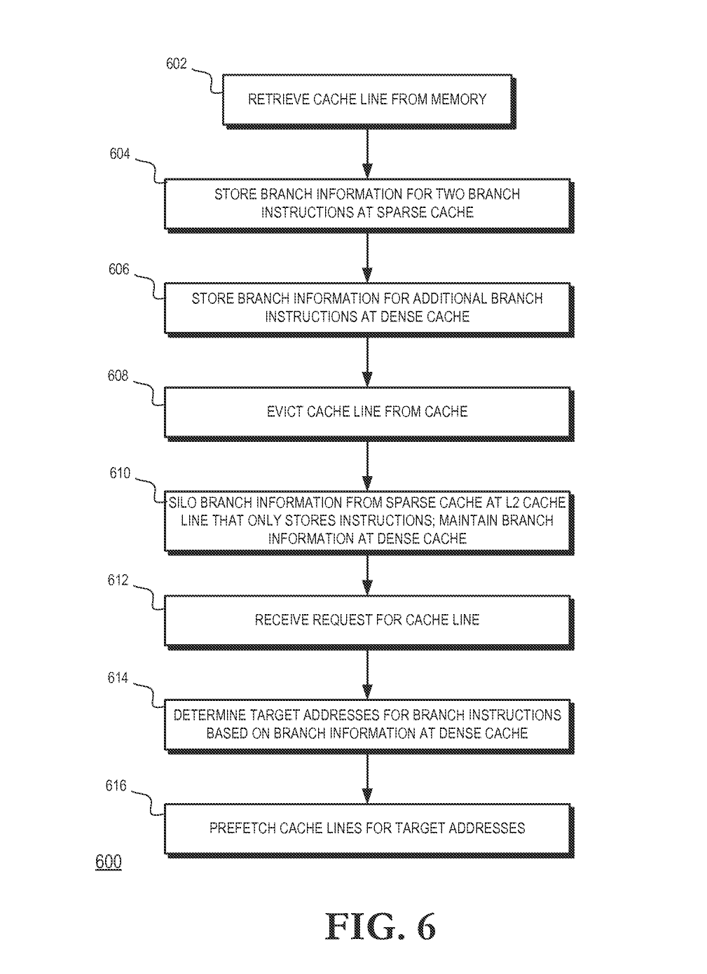

FIG. 6 illustrates a flow diagram of a method 600 of prefetching instructions to the instruction cache 104 in accordance with some embodiments. At block 602, the controller 105 transfers a cache line from the memory 150. For purposes of discussion, the transferred cache line is assumed to be the I1 cache line and the I1 cache line is assumed to have more than two branch instructions. At block 604 the controller 105 determines if there is siloed information for branch instructions of the transferred cache line at the L2 cache. If so, the controller 105 retrieves the siloed branch information and stores it at the sparse cache 106. If the L2 cache does not contain siloed branch information, the branch predictor 120 stores at the sparse cache 106 branch information for branch instructions predicted to be taken.

At block 606 the branch predictor 120 stores the branch information for additional branch instructions of the I1 cache line at the dense cache 108 in response to predicting that additional branch instructions have been taken. As described herein, the branch predictor 120 can move branch information from the sparse cache 106 based on the relative age of each of the branch instructions predicted to be taken.

At block 608 the controller 105 determines that a different cache line is to be stored at the entry of the instruction cache 104 that stores the I1 cache line. Accordingly, the I1 cache line is evicted from the instruction cache 104. In response, at block 610 the controller 105 stores the branch information associated with the I1 cache line from the sparse cache 106 at the L2 cache, but maintains the branch information associated with the I1 cache line at the dense cache 108. At block 612 the controller 105 receives from the fetch stage 115 an instruction demand for an instruction of the I1 cache line. In response, at block 614 the prefetcher 122 determines the branch target addresses associated with the I1 cache line that are stored at the dense cache 108. At block 616 the prefetcher 122 requests the controller 105 to retrieve the cache lines that include the instructions indicated by the target addresses. The prefetcher 122 thereby prefetches the cache lines concurrently with the controller 105 satisfying the instruction demand from the fetch stage 115.

In some embodiments, the apparatus and techniques described above are implemented in a system comprising one or more integrated circuit (IC) devices (also referred to as integrated circuit packages or microchips), such as the processor described above with reference to FIGS. 1-6. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

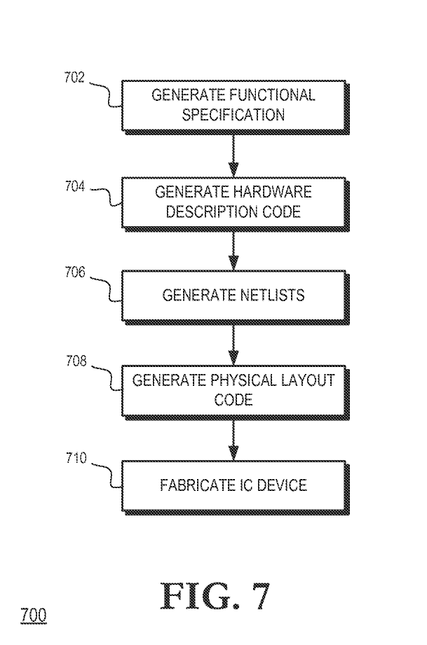

FIG. 7 is a flow diagram illustrating an example method 700 for the design and fabrication of an IC device implementing one or more aspects in accordance with some embodiments. As noted above, the code generated for each of the following processes is stored or otherwise embodied in computer readable storage media for access and use by the corresponding design tool or fabrication tool.

At block 702 a functional specification for the IC device is generated. The functional specification (often referred to as a micro architecture specification (MAS)) may be represented by any of a variety of programming languages or modeling languages, including C, C++, SystemC, Simulink, or MATLAB.

At block 704, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 706 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 708, one or more EDA tools use the netlists produced at block 906 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 710, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored on a computer readable medium that, when executed by the one or more processors, manipulate the one or more processors to perform one or more aspects of the techniques described above. The software is stored or otherwise tangibly embodied on a computer readable storage medium accessible to the processing system, and can include the instructions and certain data utilized during the execution of the instructions to perform the corresponding aspects.

In some embodiments, a method of prefetching information at a processor, includes, in response to transferring a first set of instructions to a first entry of a first cache, storing a first target address of a first branch instruction of the first set of instructions at a second cache; maintaining the first target address at the second cache in response to evicting the first set of instructions from the first entry; and in response to receiving, after eviction of the first set of instructions, a request to transfer the first set of instructions to the first cache, prefetching a second set of instructions associated with the first target address based on the first target address being maintained at the second cache. In some aspects, the method includes, in response to transferring the first set of instructions to the first entry, storing a second target address of a second branch instruction at the second cache; maintaining the second target address at the second cache in response to evicting the first set of instructions from the first entry; and in response to receiving, after eviction of the first set of instructions, the request to transfer the first set of instructions to the first cache, prefetching a third set of instructions associated with the second target address based on the second target address being maintained at the second cache. In some aspects, the method includes, in response to transferring the first set of instructions to the first entry, storing a second target address of a second branch instruction at a third cache. In some aspects, the method includes evicting the second target address from the third cache in response to evicting the first set of instructions from the first entry. In some aspects, the method includes prefetching the second set of instructions includes prefetching the second set of instructions in response to determining a type of the first branch instruction. In some aspects, the type of the first branch instruction is selected from a group consisting of a direct branch instruction and an indirect branch instruction. In some aspects, the method includes determining the type of the first branch instruction based on branch type information stored at the second cache. In some aspects prefetching the second set of instructions includes prefetching the second set of instructions in response to determining a frequency with which the first branch instruction is taken. In some aspects the method includes speculatively executing the second set of instructions in response to storing the first target address of the first branch instruction at the second cache.

In some embodiments, a method of prefetching at a processor includes: in response to storing a first set of instructions at a first entry of a first cache: identifying a plurality of branch instructions in the first set of instructions; and storing a first plurality of target addresses of a corresponding first subset of the plurality of branch instructions at a second cache; maintaining the first plurality of target addresses at the second cache in response to evicting the first set of instructions from the first cache; and in response to receiving, after eviction of the first set of instructions, a request to transfer the first set of instructions to the first cache: determining the first plurality of target addresses at the second cache; and prefetching sets of instructions corresponding to the first plurality of target addresses. In some aspects the method includes, in response to storing the first set of instructions at the first entry, storing a second plurality of target addresses of a corresponding second subset of the plurality of branch instructions at a third cache. In some aspects the method includes evicting the second plurality of target addresses from the third cache in response to evicting the first set of instructions from the first entry. In some aspects prefetching the sets of instructions comprises prefetching the sets of instructions in response to determining a corresponding type of each of the first subset of the plurality of branch instructions. In some aspects the type of each of the first subset of the plurality of branch instructions is selected from a group consisting of a direct branch instruction and an indirect branch instruction. In some aspects the method includes determining the type of each of the first subset of the plurality of branch instructions based on branch type information stored at the second cache. In some aspects prefetching the sets of instructions comprises prefetching sets of instructions in response to determining a corresponding frequency with which each of the first subset of the plurality of branch instructions is taken.

In some embodiments, a processor includes a first cache comprising a first entry to store a first set of instructions; a controller to evict the first set of instructions from the first entry; a second cache to store a first target address of a first branch instruction of the first set of instructions in response to the first set of instructions being stored at the first entry and to maintain storage of the first target after eviction of the first set of instructions; and a prefetcher to, in response to a request to transfer the first set of instructions to the first cache, prefetch a second set of instructions associated with the first target address based on the first target address being maintained at the second cache. In some aspects the second cache is to store a second target address of a second branch instruction of the first set of instructions in response to the first set of instructions being stored at the first entry and is to maintain storage of the second target address at the second cache after eviction of the first set of instructions; and the prefetcher is to, in response to the request to transfer the first set of instructions to the first cache, prefetch a second set of instructions associated with the second target address based on the second target address being maintained at the second cache. In some aspects the processor includes a third cache to store a second target address of a second branch instruction of the first set of instructions in response to the first set of instructions being stored at the first entry. In some aspects the controller is to evict the second target address from the third cache in response to evicting the first set of instructions from the first entry. In some aspects the prefetcher is to prefetch the second set of instructions in response to determining a type of the first branch instruction. In some aspects the type of the first branch instruction is selected from a group consisting of a direct branch instruction and an indirect branch instruction In some aspects the prefetcher is to determine the type of the first branch instruction based on branch type information stored at the second cache. In some aspects the prefetcher is to prefetch the second set of instructions based on a frequency with which the first branch instruction is taken.

In some embodiments a computer readable medium stores code to adapt at least one computer system to perform a portion of a process to fabricate at least part of a processor, the processor including: a first cache comprising a first entry to store a first set of instructions; a controller to evict the first set of instructions from the first entry; a second cache to store a first target address of a first branch instruction of the first set of instructions in response to the first set of instructions being stored at the first entry and to maintain storage of the first target after eviction of the first set of instructions; and a prefetcher to, in response to a request to transfer the first set of instructions to the first cache, prefetch a second set of instructions associated with the first target address based on the first target address being maintained at the second cache.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method of prefetching information at a processor, comprising:
in response to transferring a first set of instructions to a first entry of a first cache, storing a first target address of a first branch instruction of the first set of instructions at a second cache;
maintaining the first target address at the second cache in response to evicting the first set of instructions from the first entry; and
in response to receiving, after eviction of the first set of instructions, a request to transfer the first set of instructions to the first cache, prefetching a second set of instructions associated with the first target address based on the first target address being maintained at the second cache.

2. The method of claim 1, further comprising:
in response to transferring the first set of instructions to the first entry, storing a second target address of a second branch instruction at the second cache;
maintaining the second target address at the second cache in response to evicting the first set of instructions from the first entry; and
in response to receiving, after eviction of the first set of instructions, the request to transfer the first set of instructions to the first cache, prefetching a third set of instructions associated with the second target address based on the second target address being maintained at the second cache.

3. The method of claim 1, further comprising:
in response to transferring the first set of instructions to the first entry, storing a second target address of a second branch instruction at a third cache.

4. The method of claim 3, further comprising:
evicting the second target address from the third cache in response to evicting the first set of instructions from the first entry.

5. The method of claim 1, wherein prefetching the second set of instructions comprises prefetching the second set of instructions in response to determining a type of the first branch instruction.

6. The method of claim 5, wherein the type of the first branch instruction is selected from a group consisting of a direct branch instruction and an indirect branch instruction.

7. The method of claim 5, further comprising determining the type of the first branch instruction based on branch type information stored at the second cache.

8. The method of claim 1, wherein prefetching the second set of instructions comprises prefetching the second set of instructions in response to determining a frequency with which the first branch instruction is taken.

9. The method of claim 1, further comprising speculatively executing the second set of instructions in response to storing the first target address of the first branch instruction at the second cache.

10. A method of prefetching at a processor, comprising:
in response to storing a first set of instructions at a first entry of a first cache:
identifying a plurality of branch instructions in the first set of instructions; and
storing a first plurality of target addresses of a corresponding first subset of the plurality of branch instructions at a second cache;
maintaining the first plurality of target addresses at the second cache in response to evicting the first set of instructions from the first cache; and
in response to receiving, after eviction of the first set of instructions, a request to transfer the first set of instructions to the first cache:
determining the first plurality of target addresses at the second cache; and
prefetching sets of instructions corresponding to the first plurality of target addresses.

11. The method of claim 10, further comprising:
in response to storing the first set of instructions at the first entry, storing a second plurality of target addresses of a corresponding second subset of the plurality of branch instructions at a third cache.

12. The method of claim 11, further comprising:
evicting the second plurality of target addresses from the third cache in response to evicting the first set of instructions from the first entry.

13. The method of claim 10 wherein prefetching the sets of instructions comprises prefetching the sets of instructions in response to determining a corresponding type of each of the first subset of the plurality of branch instructions.

14. The method of claim 13, wherein the type of each of the first subset of the plurality of branch instructions is selected from a group consisting of a direct branch instruction and an indirect branch instruction.

15. The method of claim 14, further comprising determining the type of each of the first subset of the plurality of branch instructions based on branch type information stored at the second cache.

16. The method of claim 10, wherein prefetching the sets of instructions comprises prefetching sets of instructions in response to determining a corresponding frequency with which each of the first subset of the plurality of branch instructions is taken.

17. A processor, comprising
a first cache comprising a first entry to store a first set of instructions;
a controller to evict the first set of instructions from the first entry;
a second cache to store a first target address of a first branch instruction of the first set of instructions in response to the first set of instructions being stored at the first entry and to maintain storage of the first target after eviction of the first set of instructions; and
a prefetcher to, in response to a request to transfer the first set of instructions to the first cache, prefetch a second set of instructions associated with the first target address based on the first target address being maintained at the second cache.

18. The processor of claim 17, wherein:
the second cache is to store a second target address of a second branch instruction of the first set of instructions in response to the first set of instructions being stored at the first entry and is to maintain storage of the second target address at the second cache after eviction of the first set of instructions; and
the prefetcher is to, in response to the request to transfer the first set of instructions to the first cache, prefetch a second set of instructions associated with the second target address based on the second target address being maintained at the second cache.

19. The processor of claim 18, further comprising:
a third cache to store a second target address of a second branch instruction of the first set of instructions in response to the first set of instructions being stored at the first entry.

20. The processor of claim 19, wherein the controller is to:
evict the second target address from the third cache in response to evicting the first set of instructions from the first entry.

21. The processor of claim 20, wherein the prefetcher is to prefetch the second set of instructions in response to determining a type of the first branch instruction.

22. The processor of claim 21, wherein the type of the first branch instruction is selected from a group consisting of a direct branch instruction and an indirect branch instruction.

23. The processor of claim 21, wherein the prefetcher is to determine the type of the first branch instruction based on branch type information stored at the second cache.

24. The processor of claim 20, wherein the prefetcher is to prefetch the second set of instructions based on a frequency with which the first branch instruction is taken.

25. A computer readable medium storing code to adapt at least one computer system to perform a portion of a process to fabricate at least part of a processor, the processor comprising:
a first cache comprising a first entry to store a first set of instructions;
a controller to evict the first set of instructions from the first entry;
a second cache to store a first target address of a first branch instruction of the first set of instructions in response to the first set of instructions being stored at the first entry and to maintain storage of the first target after eviction of the first set of instructions; and
a prefetcher to, in response to a request to transfer the first set of instructions to the first cache, prefetch a second set of instructions associated with the first target address based on the first target address being maintained at the second cache.
